(19) United States
(12) Patent Application Publication
(10) Pub. No.: US 2004/0003772 A1
(43) Pub. Date: Jan. 8, 2004

(54) Apparatus and methods for dispensing fluid onto webs

(75) Inventors: Hubert Kufner, Luneburg (DE); Thomas Burmester, Bleckede (DE); Axel Krzenzck, Lauenburg (DE)

Correspondence Address: WOOD, HERRON & EVANS, L.L.P., 2700 Carew Tower, 441 Vine St., Cincinnati, OH, 45202, US

(73) Assignee: Nordson Corporation

(21) Appl. No.: 10/414,068

(22) Filed: Apr. 15, 2003

(30) Foreign Application Priority Data
Apr. 16, 2002 (DE) 10216972.1

(51) Int. Cl. B05C 5/00

(52) U.S. Cl. 118/300; 118/323

(57) ABSTRACT

A device and a process for delivering fluid to moving webs, especially for delivering an adhesive to one or more strips. An applicator head can be moved in an essentially horizontal plane by an adjusting mechanism from an operating position, in which the discharge orifice of the nozzle is located in the region of the path of movement of the web, to a maintenance position, in which the applicator head is horizontally distanced from the path of movement of the web. The process is characterized by the fact that the mass flow or volume flow of the gas stream fed to and discharged from an application device is controlled as a function of the relative speed.

### FIELD OF THE INVENTION

The present invention pertains to a device for dispensing fluid onto movable webs, especially for delivering adhesive onto at least one strip, with at least one fluid applicator head that can be connected with a fluid source and a nozzle installed on the applicator head with a discharge orifice for delivering fluid, and with at least one application valve for selective interruption or release of the fluid stream.

The invention also concerns a process for applying fluid to a web that can be moved relative to an application device, especially for delivering adhesive onto at least one strip, in which the fluid is applied to the web by an application device with the aid of a gas, such that the web is conveyed past the application device at an adjustable relative speed.

### BACKGROUND OF THE INVENTION

Devices and processes for delivering fluid to webs that can be moved relative to the device are used in various industrial applications, for example, for applying adhesives over a large area or in the form of beads or points to parts of furniture, packaging, or sanitary products, such as diapers or the like, during the production of these goods. In such applications, a web is normally moved relative to the device by a conveyance device in such a way that the fluid, such as an adhesive, is discharged from a discharge orifice of the nozzle of an applicator head and is then deposited on the web in a desired application pattern. The particular parameters of use, such as the rate of the relative motion between the web and the device (which we shall also refer to as the relative speed), the shape of the discharge orifice of the nozzle, and the type of delivery of the fluid vary according to the specific application. In some applications, the fluid is sprayed on by mixing a pressurized gas with the fluid material to be applied, e.g., an adhesive, inside the nozzle or inside a nozzle system of the applicator head at a certain pressure, so that the fluid is atomized due to the pressurized gas and is discharged in the form of fine particles and sprayed onto the web. In other applications, after a strand or strip of fluid has emerged from the discharge orifice of the nozzle, it is acted on by one or more streams of pressurized gas discharged from adjacent discharge orifices of the nozzle or nozzle system, so that the strand or strip of fluid is, for example, elongated or caused to rotate by the stream or streams of gas.

In the production of sanitary products, such as diapers or the like, elastically deformable strips or rubber bands are generally applied to parts of the product. In this regard, liquid adhesive may be applied by a device of the type mentioned at the beginning onto a plastic strip that constitutes the web, as the strip is conveyed past the device, or the adhesive may be applied to several relatively closely spaced, parallel strips conveyed past the device, and the strip or the several strips to which the adhesive has been applied are then applied to another, e.g., strip-shaped, web in the form of a plastic sheet.

In such applications, it is necessary for the discharge orifice of the nozzle of an applicator head to be very precisely aligned with the strip or the several strips. It is also necessary for the strips to be precisely conveyed past the discharge orifice of the nozzle of the applicator head in the direction of relative motion between the strip as web and the applicator head. Furthermore, in applications of this type, it is necessary to ensure relatively simple and fast adaptability of the application device to the changing application patterns that are desired and to different geometries, for example, different positionings of the strips on a sheet that is part of a sanitary product.

Another requirement of these kinds of devices for delivering fluid to webs is good accessibility to individual components of the devices for purposes of maintenance and cleaning and for changing individual parts of the device.

In applications in which a stream of gas is used during the delivery or application of fluid onto a web, e.g., in a spray process for spraying fluid or in a process in which a strand or strip of fluid is elongated, caused to rotate, or otherwise affected by streams of gas after it has been discharged from the applicator head, exact control of the gas stream or of the several gas streams in the application device is very important with respect to being able to produce a desired application pattern. In this regard, the mass flow or volume flow of the gas stream is especially important, since this quantity is related to the flow rate of the gas.

### SUMMARY OF THE INVENTION

The goal of the present invention is to develop a device for delivering fluid to webs that can be moved relative to the device, especially for delivering adhesive to a strip or to several strips, in which simple adjustment of the applicator head relative to the web is possible and there is easy accessibility to the device for purposes of maintenance, cleaning and changing components.

A further goal of the invention is precise guidance of stripary webs, e.g., plastic strips, past the applicator head, and simple adaptation to different concrete applications.

A further goal in accordance with another aspect of the invention is to develop a process for applying fluid to a web that can be moved relative to an application device, especially for delivering adhesive to a strip, in which simple control of a gas stream through a nozzle or nozzle system of the application device is realized.

The goal of the invention with respect to a device of the type mentioned above in accordance with a first aspect of the invention is achieved by making it possible to move the applicator head in an essentially horizontal plane by means of an adjusting mechanism from an operating position, in which the discharge orifice of the nozzle is located in the region of the path of movement of the web, to a maintenance position, in which the applicator head is horizontally distanced from the path of movement of the web.

With the use of an adjusting mechanism in accordance with the invention, the applicator head with its discharge orifice for the delivery of fluid can be moved simply and quickly from an operating position or application position, in which the fluid is delivered and applied to the web, into a passive position or maintenance position, in which the applicator head is horizontally shifted. In this maintenance position, the applicator head with all of its components is distanced from the path of movement of the web and from a stationary structure, for example, a wall, on which the entire applicator head and its adjusting mechanism are mounted. In this maintenance position, the applicator head and all components are much more readily accessible to users or maintenance personnel. With the use of the adjusting mechanism, the entire applicator head can be quickly shifted and moved away from any device elements that might be present for conveying webs, so that better accessibility is ensured.

In an exemplary embodiment, the adjusting mechanism has at least one essentially horizontally arranged, swiveling support arm, which can be mounted at one end on a stationary structure, especially a wall, on which it can swivel, and which supports the applicator head at its other end. A swiveling support arm of this type allows easy movement into the maintenance position or the operating position, and the constructional expense for achieving relatively large swiveling paths is low.

In another aspect of the invention, the adjusting mechanism has a first support arm, one end of which is mounted on a stationary structure, especially a wall, in such a way that it can swivel, and a second support arm, one end of which is connected to the first support arm in such a way that it can swivel, and which supports the applicator head, such that the first and second support arms are arranged essentially parallel to each other in the operating position of the applicator head and are arranged essentially in alignment with each other in the maintenance position. With the use of two support arms connected to each other in such a way that they can swivel, one of which is preferably mounted on a stationary wall or a wall mounting plate, while the other has a structure for supporting the applicator head, large paths of motion can be achieved by constructionally simple means.

In another aspect of the invention, the first support arm may be supported on a wall mounting plate in such a way that it can swivel, and the wall mounting plate can be moved by a mounting and adjusting mechanism essentially vertically relative to a stationary wall and can be locked in different, infinitely adjustable vertical positions. With the use of this type of mounting and adjusting mechanism, it is possible to achieve exact vertical orientation of the applicator head and thus of the discharge orifice of the applicator head in such a way that continuous and precise adjustment is easily accomplished. It is advantageous for the mounting and adjusting mechanism to have a pivoted threaded shaft and a threaded member that is engaged with the threaded shaft and rigidly attached to the wall mounting plate, so that, when the threaded shaft is turned, the mounting plate and thus the adjusting mechanism, together with the applicator head, can be moved vertically and locked in continuously adjustable vertical positions.

In yet another aspect of the invention, one or more applicator heads are supported by a first linear shift mechanism so that they can be moved linearly in the direction of the relative motion between the application device and the web and locked in place. This type of (first) linear shift mechanism for linear movement of the applicator head in the direction of relative motion between the application device and the web, makes it possible in a simple way to move the applicator head into an optimum position for maintenance purposes or cleaning purposes, so that the given work can be performed as effectively as possible. In addition, due to the linear mobility of the applicator head essentially in the direction of relative motion, it is also possible to achieve exact positioning of the discharge orifice of the nozzle relative to a web. For example, if the web is a strip, say, a rubber band, to which adhesive is to be applied, and if the strip in the adjustment region of the linear guide runs slightly upward or downward through a suitable strip guide, then the distance between the discharge orifice and the strip can be easily adjusted by linear movement in the direction of relative motion.

In one exemplary embodiment, the first linear shift mechanism has a guide rail that runs in the direction of relative motion, a mounting plate supported on the guide rail by roller bearings for mounting the applicator head, and a threaded shaft that can be turned by a handwheel, such that the threaded shaft interacts with a threaded member in such a way that the applicator head moves linearly when the threaded shaft is turned.

In another exemplary embodiment, the applicator head, together with the first linear shift mechanism, is supported by a second linear shift mechanism, so that it can be moved linearly in the direction perpendicular to the relative motion between the application device and the web and locked in place. The second linear shift mechanism makes it possible to move and precisely adjust the applicator head additionally more or less perpendicularly to the direction of relative motion between the application device and the web, for example, a strip. In this way, for example, the site of placement of an adhesive-treated strip on a plastic sheet or the like can be varied during the production of sanitary products, and easy adaptation to different geometries can be made.

In another aspect of the invention, the second linear shift mechanism has a guide rail that runs perpendicularly to the direction of relative motion, a mounting plate supported on the guide rail by roller bearings for mounting the first linear shift mechanism, and a threaded shaft that can be turned by a handwheel, such that the threaded shaft acts together with a threaded member attached to the mounting plate in such a way that the linear movement of the applicator head perpendicular to the direction of relative motion is effected when the threaded shaft is turned. An operator is able to make adjustments very quickly and easily with this type of handwheel.

In an exemplary embodiment, at least one guide roller for guiding a strip to be coated with fluid is provided, which is supported on a mounting plate and can be moved in the direction perpendicular to the direction of relative motion between the applicator head and the web. With a guide roller of this type, a strip to be coated can be precisely positioned relative to a discharge orifice of the nozzle of the applicator head. It is also possible for several strips to be guided parallel to one another by means of a guide roller with several grooves or slots and then to be conveyed past several discharge orifices for the delivery of fluid. The guide roller, which is supported on a mounting plate and can be adjusted perpendicularly to the direction of relative motion, can be adjusted by a handwheel, so that a fine adjustment can be made in an easy way without tools.

In another exemplary embodiment, the strip guide roller may be linearly adjusted by a handwheel coupled with a threaded shaft. In this way, in the fine adjustment described above, an additional change and adjustment of the position of the strip guide roller perpendicular to the direction of relative motion can be performed.

In yet another exemplary embodiment, at least two applicator heads are arranged at a certain distance from each other, each applicator head can be moved by its own first linear shift mechanism in the direction of relative motion, and each applicator head can be moved by its own second linear shift mechanism perpendicularly to the direction of relative motion. In this way, further individual adaptation to the requirements of the specific fluid application is possible.

In another aspect of the invention, the mass flow or volume flow of a gas stream fed to the application device and delivered by the application device is controlled as a function of the relative speed. Accordingly, in all applications in which a gas stream is used during the application process to affect the fluid that is to be applied, for example, in a spray application or some other type of influencing a delivered stream of fluid by streams of gas, there is a predeterminable coupling between speed and gas stream. This is advantageous in many applications.

In an exemplary embodiment, the volume flow of the gas stream is controlled as a function of the relative speed in such a way that the volume flow of the gas stream increases with increasing relative speed. In this regard, especially a proportional dependence on the relative speed can be realized.

In another exemplary embodiment, even when a value of the relative speed between the applicator head and the web that approaches zero or is equal to zero, a mass flow or volume flow of the gas stream continues to be supplied and to flow through the discharge orifice of the nozzle to prevent obstructions of the discharge orifice from developing. This stream of air may also be designated as a cleaning air stream. Advantageously, as long as the gas stream is being discharged, no particles, e.g., of dust or other contaminants, can enter the discharge orifice. When the relative speed is increased, then the cleaning air stream is increased further in the manner described above.

### BRIEF DESCRIPTION OF DRAWINGS

The invention is described below with reference to the preferred embodiments shown in the accompanying drawings.

FIG. 1 shows a perspective view of an exemplary embodiment of a device in accordance with the invention for delivering fluid in the operating position.

FIG. 2 shows a top view of the device of FIG. 1.

FIG. 3 shows a side view of the device of FIG. 1 in the direction of movement of a web relative to the device.

FIG. 4 shows another side view of the device of FIG. 1.

FIG. 5 shows a perspective view of the device of FIG. 1 in the maintenance position.

FIG. 6 shows a top view of the device of FIG. 5 in the maintenance position.

FIG. 7 shows a side view of the device of FIG. 5 in the maintenance position.

FIG. 8 shows another perspective view of the device of FIG. 5 in the maintenance position.

FIG. 9 shows perspective views of a strip roller with adjusting mechanism.

FIG. 10 shows part of another exemplary embodiment of the invention.

FIG. 11 shows another perspective view of the exemplary embodiment of FIG. 10.

FIG. 12 shows another perspective view of the exemplary embodiment of FIG. 10.

FIG. 13 shows another perspective view of the exemplary embodiment of FIG. 10.

FIG. 14 shows a schematic representation of an applicator head with control, in accordance with the invention, of the mass flow or volume flow of the gas stream as a function of the relative speed.

FIG. 15 shows a graph that illustrates the relationship between relative speed and volume flow or mass flow of the gas stream.

### DETAILED DESCRIPTION

With reference to the Figures, various exemplary embodiments of the device of the invention which are specifically adapted to the delivery and application of fluid adhesive onto one or more strips of plastic for the production of sanitary products are shown and described herein. However, it will be recognized that the device can also be used in other applications involving the application of fluid to different webs. The illustrated embodiments have two fluid applicator heads 2, 4, which can be moved and thus adjusted in several directions by means of a support structure or support device in accordance with the invention. The support structure is described in detail below.

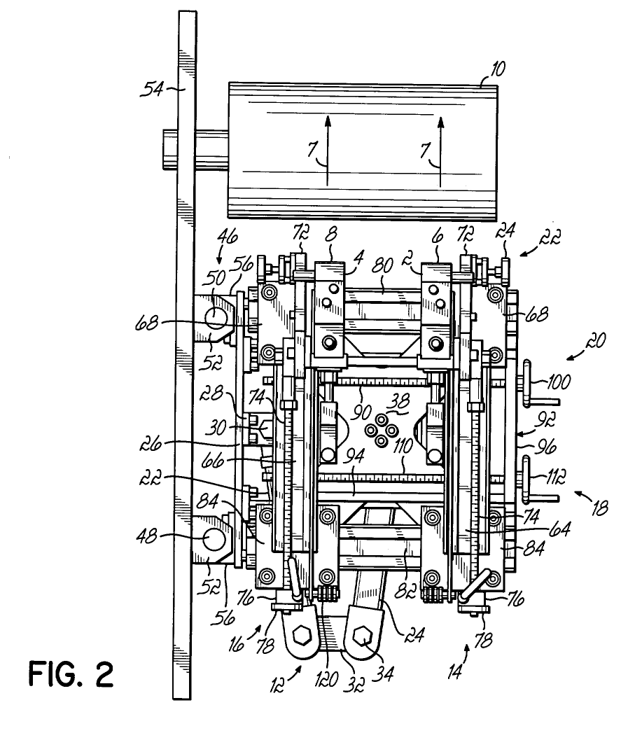

The applicator heads 2, 4 have application modules of a type that is well known, with at least one discharge orifice for the delivery of fluid. The application modules are attached to the applicator heads 2, 4. The nozzles of the applicator heads 2, 4 are indicated in FIG. 2 by reference numbers 6 and 8. Fluid is thus delivered essentially horizontally through the nozzles 6, 8 and then applied to one or more strips, which are conveyed past the applicator heads 2, 4 below the nozzles 6, 8 in the direction indicated by the arrows 7 in a manner described in greater detail below (FIG. 2). This direction is also referred to as the direction of relative motion. The applicator heads 2, 4 are connected to sources of adhesive (not shown). The flow of fluid through the applicator heads 2, 4 can be started and stopped by well-known means involving the use of valve systems, which are not shown in the drawings. The applicator heads 2, 4 are designed in such a way that they simultaneously admit a gas stream, especially a stream of air, in such a way that gas streams, which are discharged from discharge orifices (not shown) located in the region of the nozzles 6, 8, act on the strand of adhesive being discharged from the nozzles 6, 8. Alternatively, the applicator heads 2, 4 could also have spray nozzles, in which a fluid is atomized with the use of compressed gas and then sprayed onto the strips or other webs. The strips to which adhesive has been applied are then deposited in the region of a schematically represented roll 10 on a web in the form of a sheet, which is conveyed by the roll 10 and also moves in the direction of relative motion 7, so that an adhesive connection is formed between the strips and the sheet, from which a sanitary product can be produced.

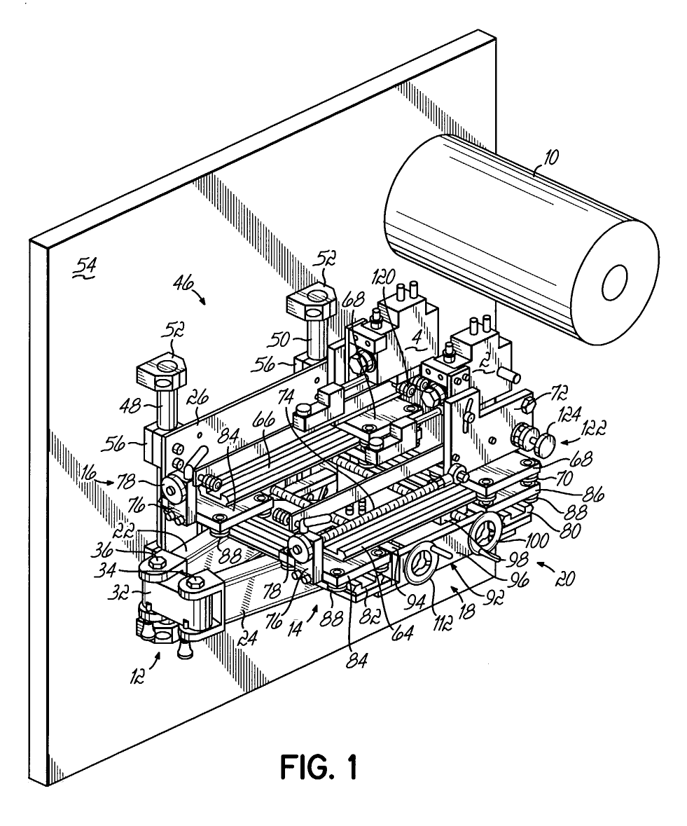

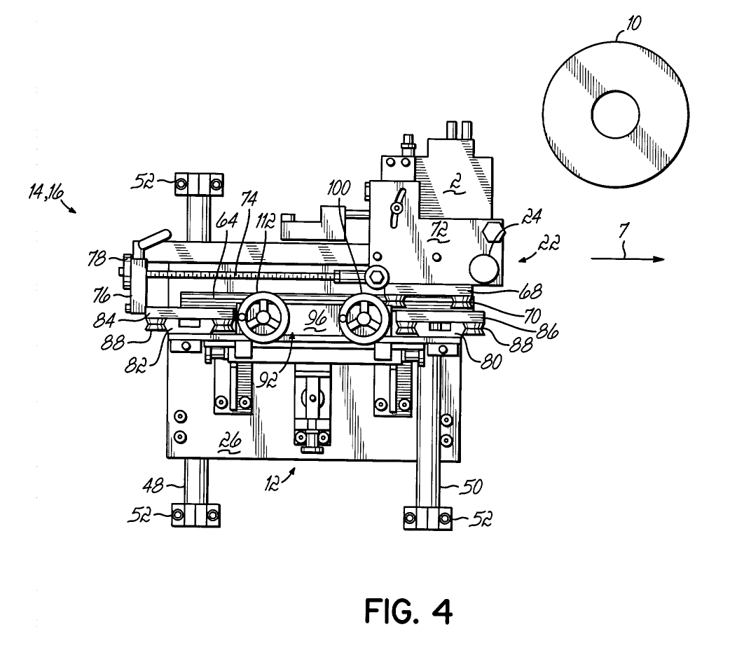

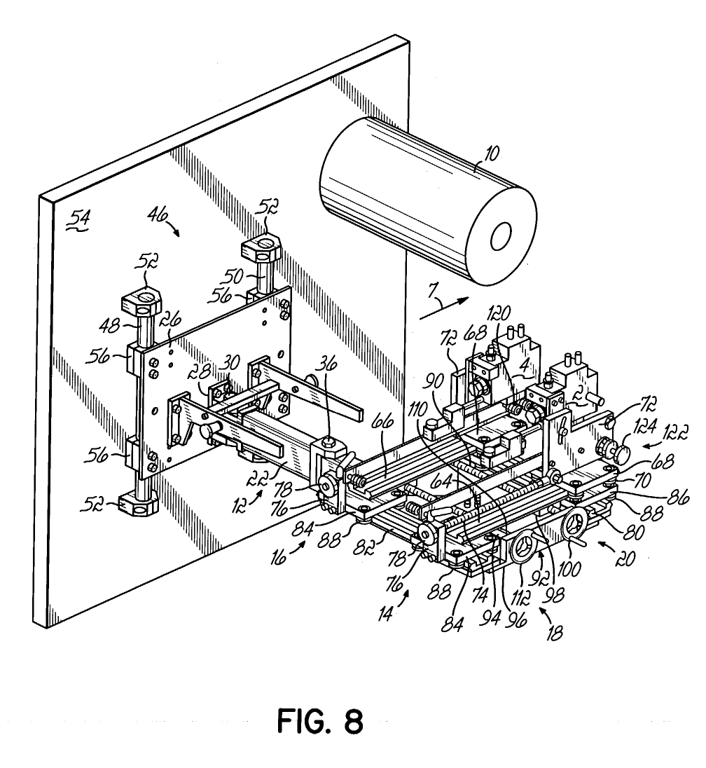

With continued reference to FIGS. 1-8, the support structure for supporting the applicator heads 2, 4 allows the applicator heads 2, 4 to be moved and locked in the vertical direction and also to be moved and locked in any desired position in the horizontal plane. For this purpose, the support structure has an adjusting mechanism 12 and, for each applicator head 2, 4, a first linear shift mechanism 14, 16 (FIG. 2), respectively, and a second linear shift mechanism 18, 20 (FIG. 1), respectively.

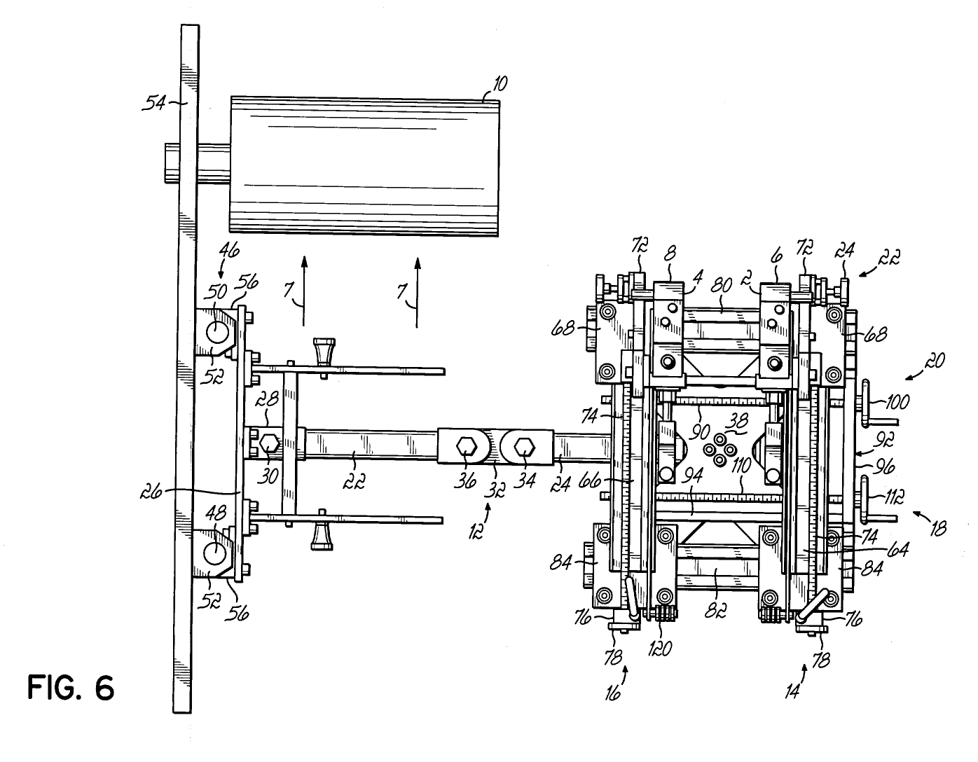

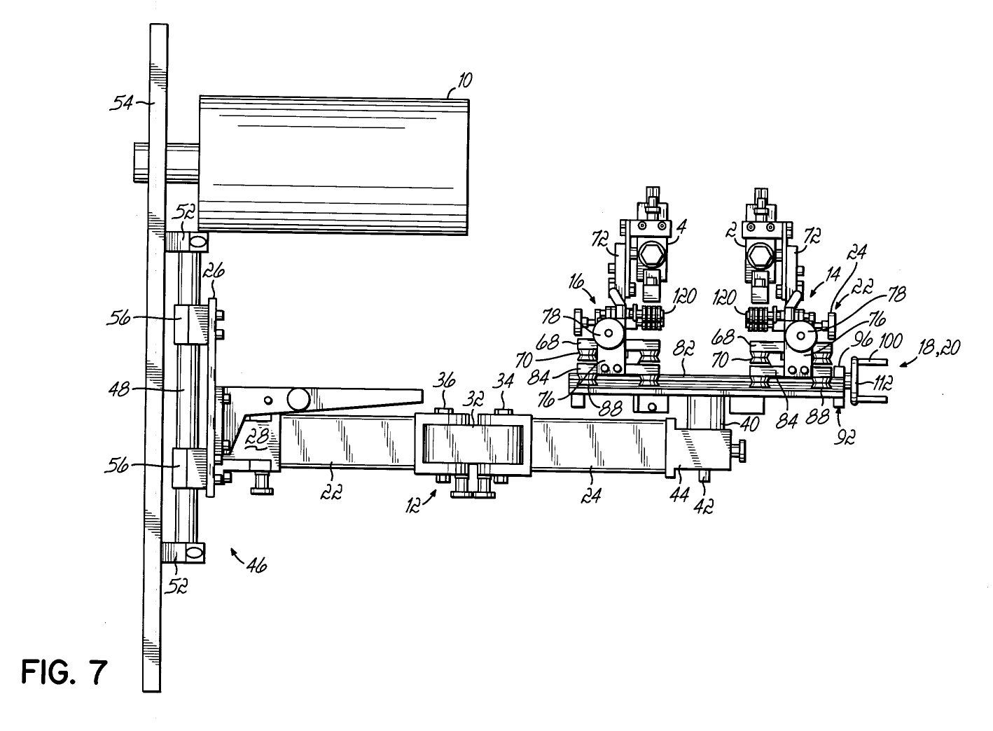

The adjusting mechanism 12 comprises a first support arm 22 and a second support arm 24. One end of the first support arm 22 is supported on a wall mounting plate 26 in such a way that it can swivel about a vertical axis. A mounting fixture 28 with two aligned drill holes and a bolt 30 is used to achieve this support (see FIG. 6). The first and second support arms 22, 24 are coupled in such a way that they can swivel relative to each other by means of a connector 32 and by means of bolts 34, 36, which are inserted through drill holes in the connector 32. It is also possible, in a manner not shown, to support the support arms 22, 24 directly on each other by means of a bolt, so they can swivel about a vertical axis. At its free end, the second support arm 24 is detachably coupled by several screws with a support plate 38 (see FIGS. 2 and 6), and the support plate 38 is installed by means of an adapter 40 with a lower bolt extension 42, so that it can turn relative to the free end of the support arm 24 (FIG. 7). For this purpose, a mounting extension 44 is attached to the free end of the support arm 24.

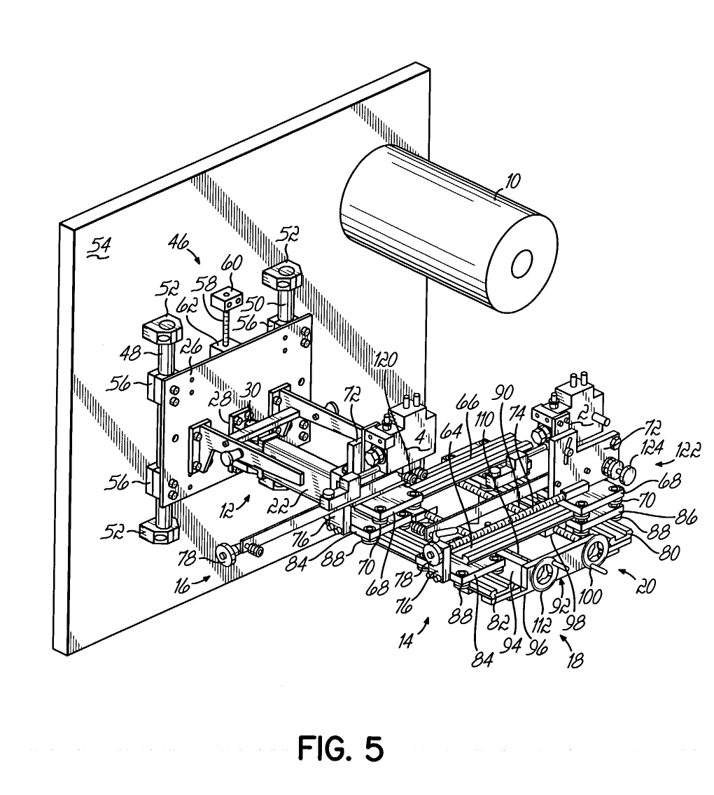

The adjusting mechanism 12 with its support arms 22, 24 makes it possible to move both applicator heads 2, 4 in an essentially horizontal plane. FIGS. 1-4 show the support arms 22, 24 in an operating position or application position in which the support arms 22, 24 are arranged essentially parallel to each other (the support arms 22, 24 are not oriented exactly parallel to each other, but are arranged at only a very small angle to each other). The support arms 22, 24 can be moved into a maintenance position, as depicted in FIGS. 5-8, by manually swiveling them. In the maintenance position, the support arms 22, 24 are aligned in a straight line, as shown, for example, in FIGS. 5, 6, and 7. In the maintenance position, the applicator heads 2, 4 and all other components are located at a distance from the path of movement of the web (compare arrows 7 in FIGS. 2 and 6) and are readily accessible for cleaning, maintenance, or installation work.

A mounting and adjusting mechanism 46 permits vertical adjustment and locking of the wall mounting plate 26 and all of the components of the device that are supported on the wall mounting plate 26, including the support arm 22, the support arm 24, and the applicator heads 2, 4, which are supported by the support arms 22, 24 in a manner described in greater detail below.

As shown in FIGS. 1 to 6, the mounting and adjusting mechanism 46 has two vertical, parallel round rods 48, 50, which are mounted at their ends to a wall 54 or other stationary structure by means of wall mounting devices 52. The wall mounting plate 26 can be detachably connected with the round rods 48, 50 by means of several clamp fasteners 56. Several clamping screws are provided on the clamp fasteners 56 to release the connection. By loosening the clamp fasteners 56, the whole mounting plate 26 can be moved vertically up and down and then locked by reclamping the clamp fasteners 56.

As is shown only in FIG. 5, a pivoted threaded shaft 58 is mounted on the wall 54 between the round rods 48, 50 by two wall fastening elements 60 in such a way that it can turn. The threaded shaft 58 is engaged with a threaded member 62, which is rigidly attached to the mounting plate 26. When the threaded shaft 58 is turned by suitable turning tools, and the clamp fasteners 56 are loosened, the whole wall mounting plate 26, together with all of the components supported on it, including the applicator heads 2, 4, can be reliably moved up and down without the occurrence of jerky movements or a spontaneous drop. Instead, precise fine adjustment in the vertical direction can be accomplished. The clamp fasteners 56 can then be relocked.

The support structure in accordance with the invention has several linear shift mechanisms, which are described below, for linear movement of the applicator heads 2, 4 in essentially horizontal planes.

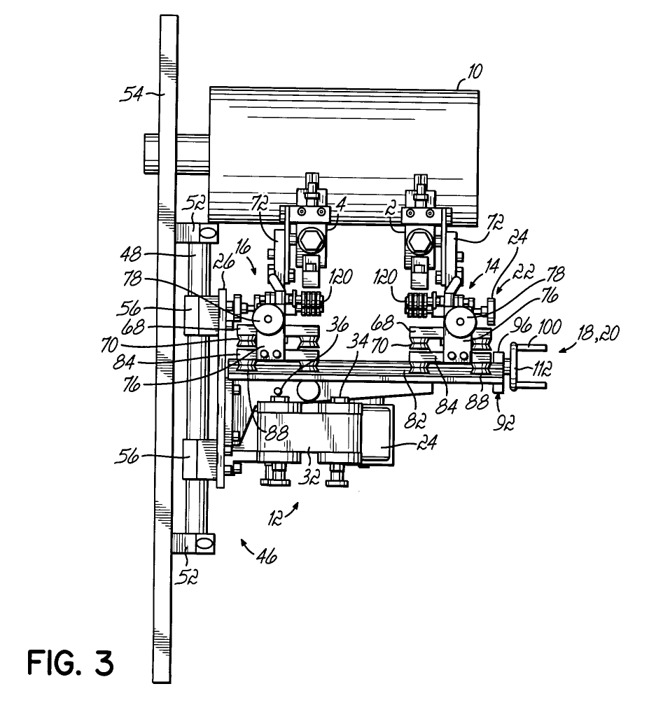

Each applicator head 2, 4 is assigned a first linear shift mechanism 14 or 16, respectively (see FIGS. 1 and 3), with which the applicator heads 2, 4 can be moved linearly back and forth in the direction of relative motion, i.e., in the direction of the arrows 7, and locked in any desired positions. As FIG. 5 shows, each first linear shift mechanism 14, 16 has a guide rail 64, 66 that runs in the direction of relative motion 7 and is indirectly supported by the support arms 22, 24 and the support plate 38. Each linear shift mechanism 14, 16 has a mounting plate 68, in whose corner sections a guide roller 70 is pivoted about a vertical axis by means of roller bearings (see FIG. 3). The guide rollers 70 are arranged in opposing pairs on the guide rails 64, 66, so that the mounting plates 68 can be moved linearly in the direction of relative motion 7 with practically no play. An applicator head support plate 72, which runs essentially vertically, is mounted on each mounting plate 68. The applicator heads 2, 4 are screwed onto this support plate 72, so that linear movement of the support plates 68 also results in linear movement of the applicator heads 2, 4 in the direction of relative motion 7.

In addition, each linear shift mechanism 14, 16 has a threaded shaft 74 (see FIG. 2), one end of which is coupled with the mounting plate 68. Each threaded shaft 74 is engaged with a plate-shaped threaded member 76 with an internal thread in such a way that, when the threaded shaft 74 is turned by a handwheel 78, there is linear movement of the mounting plate 68 and thus of the applicator heads 2, 4. In FIG. 5, applicator head 4 has been shifted linearly relative to applicator head 2.

Each applicator head 2 or 4 can be moved linearly and locked in place in a direction perpendicular to the direction of relative motion 7 between the application device and the web by means of its own second linear shift mechanism 18, 20 (see FIGS. 1 and 6). The second linear shift mechanisms 18, 20 have two guide rails 80, 82 that run essentially horizontally perpendicular to the direction of relative motion 7. The entire first linear shift mechanism 14 can be moved along the guide rails 80, 82 by means of two support plates 84, 86 and by means of guide rollers 88 mounted on the support plates 84, 86. As, for example, FIG. 5 shows, the threaded member 74 is screwed onto the support plate 84, and the support plate 86 holds the guide rail 64. The applicator head 2 can thus be moved in the direction of the longitudinal axes of the guide rails 80, 82 and perpendicularly to the direction of relative motion 7. To allow simple manual movement, a first threaded shaft 90 is journaled through a frame 92 held by the support plate 38 (FIG. 2). The frame 92 has two plates 94, spaced a certain distance apart, and side plates 96, one of each being visible in FIG. 5. In addition, the threaded shaft 90 engages a threaded member 98, which is mounted on the guide rail 64. By turning the threaded shaft 90, which is coupled with a handwheel 100, the guide rail 64 is thus moved, together with the mounting plates 84, 86 and thus the whole first linear shift mechanism 14 moves in a direction along the longitudinal axes of guide rails 80, 82.

Another second linear shift mechanism 18 serves the purpose of moving the applicator head 4. For this purpose, two mounting plates 84, 86 (see FIGS. 2-3) are also supported on the guide rail 82 by rollers 88 to allow them to move. By means of another threaded shaft 110, which is journaled through the frame 92 and engages a threaded member mounted on the guide rail 66, it is possible to move linearly back and forth the entire guide rail 66, together with the applicator head 4 in a direction along the longitudinal axes of guide rails 80, 82. For this purpose, a handwheel 112 is connected with the threaded shaft 110.

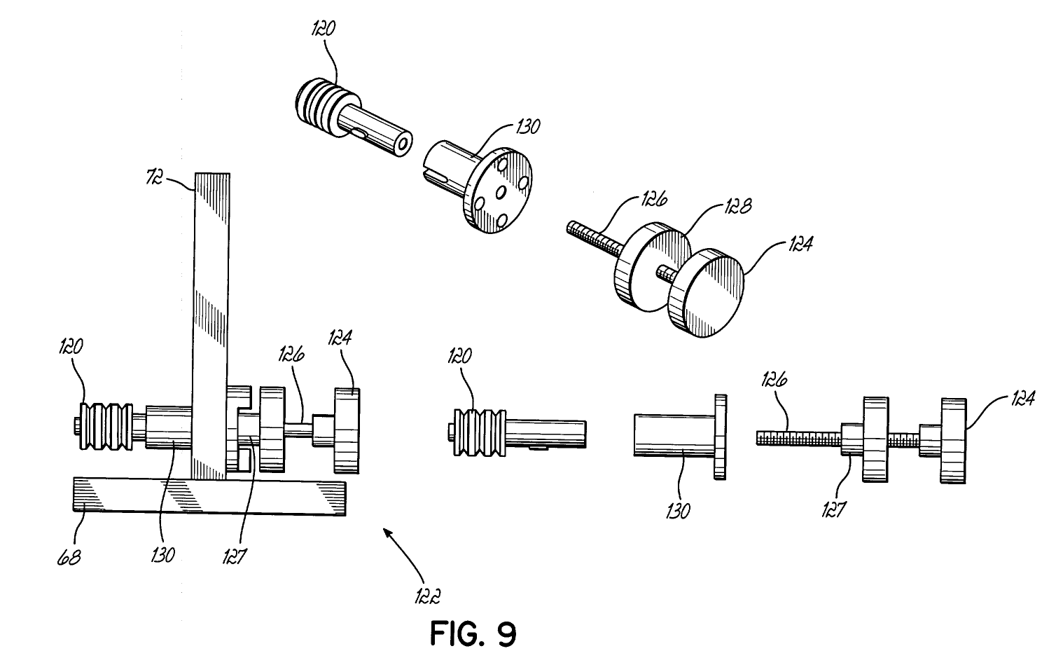

FIG. 9 shows an exemplary strip guide roller 120 that is mountable to support plates 72 associated with the respective applicator heads 2, 4. Strip guide rover 120 is rotatably secured to the distal end of a telescoping member 132, having a tapped hole 138 for threadably receiving threaded shaft 126. The telescoping member 132 and threaded shaft 126 are threadably coupled together and mounted to support plate 72 by a guide sleeve 130 having a central bore configured to receive the telescoping member 132 and threaded shaft 126 therein. A boss 134 formed on an exterior surface of telescoping member 132 engages a slot 136 formed in the guide sleeve 130 whereby rotation of threaded shaft 126 by manipulation of a handwheel 124 coupled to the threaded shaft 126 causes the telescoping member, and thus the strip guide roller 120 to translate along the threaded shaft 126. When the strip guide roller 120 is at a desired position on threaded shaft 126, the position may be secured by tightening a locknut 127, disposed on threaded shaft 126, against the guide sleeve 130. A knob 128 fixed to locknut 127 facilitates hand tightening of locknut 127.

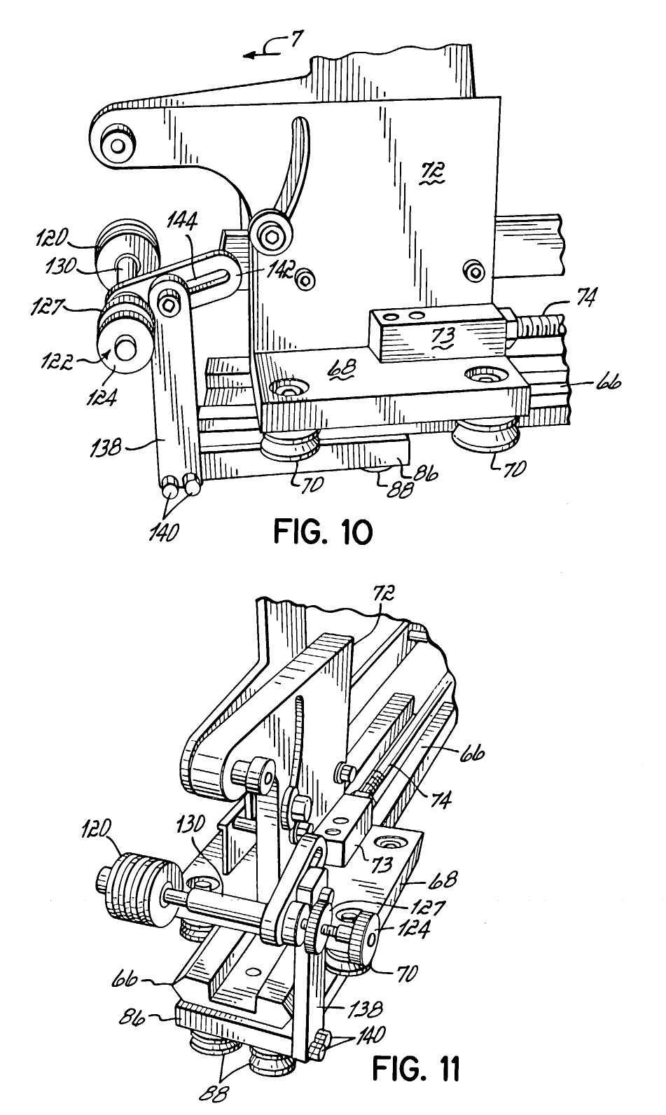

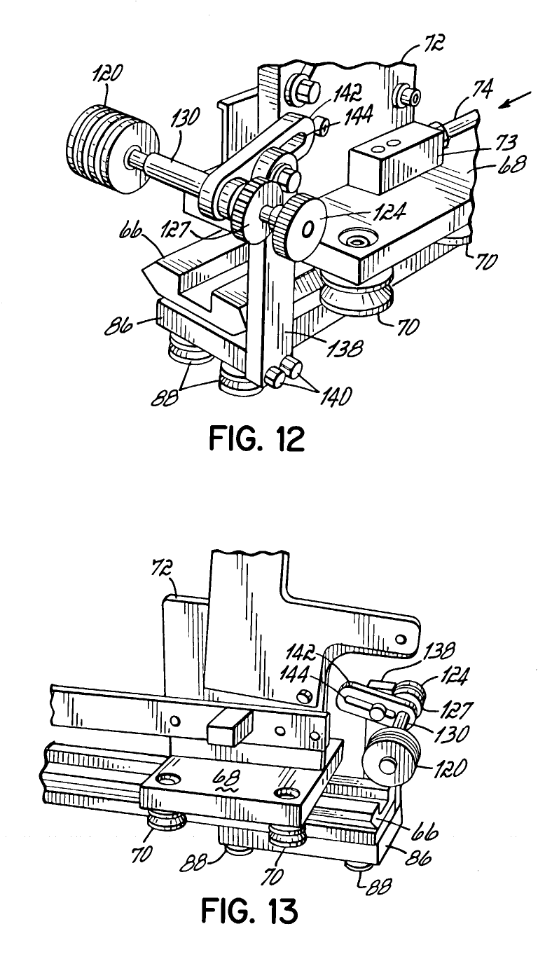

With reference to FIGS. 10-13, another exemplary embodiment of the present invention will now be described. This exemplary embodiment has basically the same design as the embodiment described above, thus only the differences will be discussed in detail. The differences involve essentially the arrangement of a strip guide roller 120 (see FIG. 9) on the support structure of the invention and the arrangement of the strip guide roller 120 relative to the applicator heads 2, 4. As described above in the first embodiment, each applicator head 2, 4 of the exemplary embodiment shown in FIGS. 10-13 is mounted on the mounting plate 72.

The mounting plate 72 for mounting the applicator heads 2, 4 is seen in FIG. 10. An applicator head 2, 4 is not shown here. FIG. 10 shows a threaded rod 74 of the linear shift mechanisms 14, 16. It is connected with the mounting plate 72 by means of a block 73. The support plate 68 with the guide rollers 70, which run along the guide rail 64, is also shown. A bracket 138 is screwed onto a rear end section of the guide rail 64, 66, i.e., behind or downstream with respect to the direction of relative motion 7, with screws 140. The bracket 138 supports the strip guide roller 120 as well as the adjusting mechanism 122. The adjusting mechanism 122 in this embodiment is basically similar in design to the adjusting mechanism 122 described above with respect to FIG. 9. A bracket 142 with a slot 144 is screwed onto the vertical support arm 138. The guide sleeve 130 (see FIG. 9) is locked in place on a threaded shaft 126 with a locknut 127 at the rear end of the bracket 142 with respect to the direction of relative motion 7. The threaded shaft 126 can be moved by a handwheel 124 to adjust the position of the strip guide roller 120 along the longitudinal axis of the threaded shaft 126. In this embodiment, the strip guide roller 120 remains in its position in the event that the mounting plate 68 and the mounting plate 72, along with an applicator head 2, 4, are adjusted by turning the threaded shaft 74 of the first linear shift mechanism in the direction of relative motion 7. The strip guide roller 120 is not shifted linearly with the applicator head 2, 4, but rather remains fixed in position. An additional possibility of adjustment in the direction perpendicular to the direction of relative motion 7 of the guide roller 120 is obtained in this embodiment by adjustment of the handwheel 100 to move the second linear shift mechanisms 18, 20.

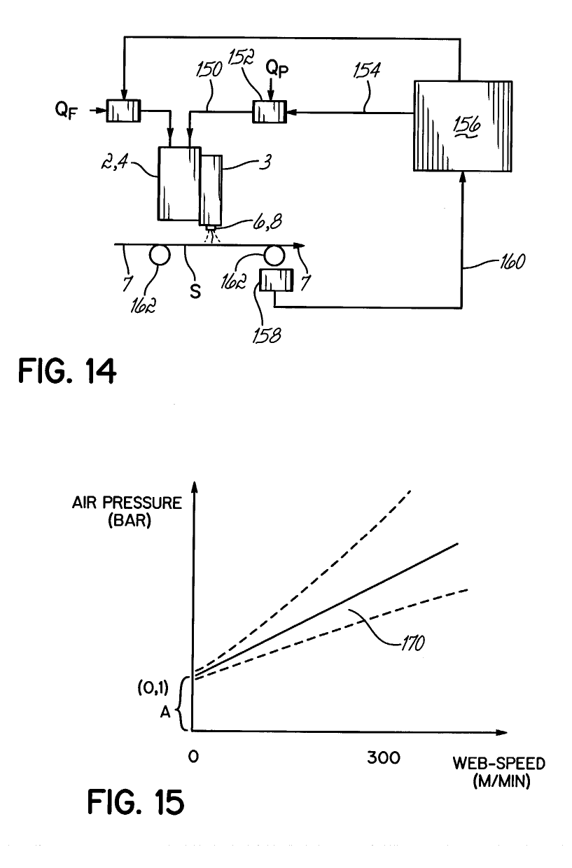

FIG. 14 illustrates an exemplary method of the invention and the control, in accordance with the invention, of the compressed gas feed to an applicator head 2, 4. The one applicator head or several schematically represented applicator heads 2, 4 have an application module 3 with a nozzle or nozzle system 6, 8 (see FIG. 2) for delivering fluid onto a web S. The web S, for example, a strip, moves in the direction of the arrow 7 at an adjustable speed or relative speed. Compressed gas, here compressed air from a compressed air source Q, is fed to the applicator head 2, 4 through a line 150 by means of an adjustable throttling device 152, such as a valve. The pressure in the line 150 and thus the pressure supplied to the applicator head 2, 4 can be adjusted in this way. This pressure represents a measure of the mass flow or volume flow of the compressed gas to the applicator head 2, 4 and through the nozzles 6, 8.

The throttling device 152 is controlled by a control and regulation unit 156 through a line 154. The speed of the web S, i.e., the relative speed between the web S and the applicator head 2, 4, is determined by a sensor 158, and a corresponding signal is supplied to the control unit 156 through a line 160. The sensor 158 may interact, for example, with a schematically indicated conveyance mechanism 162 for conveying the web S. In the control unit 156, the signal supplied by the sensor 158, which is then a measure of the relative speed, is processed, and an output signal to control the throttling device 152 is supplied through line 154, so that the mass flow or volume flow of the compressed gas or the pressure of the compressed gas is controlled as a function of the speed of the web S relative to the applicator heads 2, 4, as detected by the sensor 158.

FIG. 15 illustrates the process of the invention for applying fluid onto a web that can be moved relative to an application device and especially for delivering adhesive onto at least one strip. The process is carried out in such a way that, as curve 170 shows, the pressure of the gas, e.g., the atomizing air, and thus the mass flow or volume flow of the stream of gas fed to and discharged from the application device is controlled as a function of the relative speed. Preferably, the volume flow of the gas stream is controlled as a function of the relative speed in such a way that the volume flow of the gas stream increases with increasing relative speed. The volume flow of the gas stream preferably increases linearly proportionally as a function of the relative speed, as the straight curve shows; however, progressively increasing or degressively falling curves are also provided, as indicated by the broken curves.

Preferably, a minimum pressure and thus a minimum volume flow (“cleaning air”) of the gas is fed to the application device, even when the relative speed approaches or equals zero, as illustrated by the interval A.

What is claimed is:

1. Device for delivering fluid to movable webs, especially for delivering adhesive to at least one strip, with at least one fluid applicator head (2, 4) that can be connected with a source of fluid, with a nozzle (6, 8) that is mounted on the applicator head (2, 4) and has a discharge orifice for delivering fluid, and with at least one applicator valve for selectively starting or stopping the flow of fluid, characterized by the fact that the applicator head (2, 4) can be moved in an essentially horizontal plane by means of an adjusting mechanism (12) from an operating position, in which the discharge orifice of the nozzle is located in the region of the path of movement of the web, to a maintenance position, in which the applicator head is horizontally distanced from the path of movement of the web.

2. Device in accordance with claim 1, characterized by the fact that the adjusting mechanism (12) has at least one essentially horizontally oriented, swiveling support arm (22), which can be mounted at one end on a stationary structure, especially a wall, on which it can swivel, and which supports the applicator head (2, 4) at its other end.

3. Device in accordance with claim 2, characterized by the fact that the adjusting mechanism (12) has a first support arm (22), one end of which is mounted on a stationary structure, especially a wall, and a second support arm (24), which is connected with one end of the first support arm (22) in such a way that it can swivel and which supports the applicator head (2, 4), such that the first and second support arms (24) are arranged essentially parallel to each other in the operating position of the applicator head (2, 4) and are arranged essentially in alignment with each other in the maintenance position.

4. Device in accordance with claim 2, characterized by the fact that the first support arm (22) is supported on a wall mounting plate (26) in such a way that it can swivel, and the wall mounting plate (26) can be moved by a mounting and adjusting mechanism essentially vertically relative to a stationary wall and can be locked in different, infinitely adjustable vertical positions.

5. Device in accordance with claim 4, characterized by the fact that the mounting and adjusting mechanism has a pivoted threaded shaft and a threaded member that is engaged with the threaded shaft (58) and rigidly attached to the wall mounting plate (26), so that, when the threaded shaft is turned, the mounting plate and thus the adjusting mechanism, together with the applicator head (2, 4), can be moved vertically and locked in continuously adjustable vertical positions.

6. Device for delivering fluid to movable webs, especially in accordance with claim 1, with at least one fluid applicator head that can be connected with a source of fluid, with a nozzle that is mounted on the applicator head and has a discharge orifice for delivering fluid, and with at least one applicator valve for selectively starting or stopping the flow of fluid, characterized by the fact that the one or more applicator heads (2, 4) are supported in such a way by a first linear shift mechanism (14, 16) that they can be moved linearly in the direction of the relative motion between the application device and the web and locked in place.

7. Device in accordance with claim 6, characterized by the fact that the first linear shift mechanism has a guide rail (64, 66) that runs in the direction of relative motion, a mounting plate (68) supported on the guide rail (64, 66) by roller bearings for mounting the applicator head (2, 4), and a threaded shaft (74) that can be turned by a handwheel (78), such that the threaded shaft interacts with a threaded member (76) in such a way that the applicator head moves linearly when the threaded shaft is turned.

8. Device in accordance with claim 6, characterized by the fact that the applicator head, together with the linear shift mechanism, is supported in such a way by a second linear shift mechanism (18, 20) that it can be moved linearly in the direction perpendicular to the direction of relative motion between the application device and the web and locked in place.

9. Device in accordance with claim 8, characterized by the fact that the second linear shift mechanism has at least one guide rail (80, 82) that runs perpendicularly to the direction of relative motion, a mounting plate (84, 86) supported on the guide rail (80, 82) by roller bearings for mounting the first linear shift mechanism (14, 16), and a threaded shaft that can be turned by a handwheel and that interacts with a threaded member attached to the mounting plate in such a way that the applicator head moves linearly in the direction perpendicular to the direction of relative motion when the threaded shaft is turned.

10. Device in accordance with claim 6, characterized by the fact that there is at least one guide roller (120) for guiding a strip that is to be coated with fluid, which is supported on a mounting plate (72) and can be adjusted in the direction perpendicular to the direction of relative motion between the applicator head and the web.

11. Device in accordance with claim 10, characterized by the fact that the strip guide roller (120) can be linearly adjusted by means of a handwheel (124) coupled with a threaded shaft (126).

12. Device in accordance with claim 11, characterized by the fact that the mounting plate (72) that supports the strip guide roller (120) can be moved perpendicularly to the direction of relative motion by the second linear shift mechanism (18, 20).

13. Device in accordance with claim 6, characterized by the fact that at least two applicator heads (2, 4) are arranged at a certain distance from each other, that each applicator head can be moved by its own first linear shift mechanism (14, 16) in the direction of relative motion, and that each applicator head (2, 4) can be moved by its own second linear shift mechanism (18, 20) perpendicularly to the direction of relative motion.

14. Process for applying fluid to a web that that can be moved relative to an application device, especially for delivering an adhesive to at least one strip, in which the fluid is applied to the web by an application device under the simultaneous influence of a gas, such that the web is conveyed past the application device at an adjustable relative speed, characterized by the fact that the mass flow or volume flow of the stream of gas fed to and discharged from the application device is controlled as a function of the relative speed.

15. Process in accordance with claim 14, characterized by the fact that the volume flow of the gas stream is controlled as a function of the relative speed in such a way that the volume flow of the gas stream increases with increasing relative speed.

16. Process in accordance with claim 15, characterized by the fact that the volume flow of the gas stream increases linearly proportionally as a function of the relative speed.

17. Process in accordance with claim 14, characterized by the fact that a minimum volume flow of the gas is fed to the application device, even when the relative speed approaches or equals zero.
